(19) United States
(12) Patent Application Publication
(10) Pub. No.: US 2016/0201824 A1
(43) Pub. Date: Jul. 14, 2016

(54) ZERO POCKET VALVE

(71) Applicant: Marion Mixers, Inc., Marion, IA (US)

(72) Inventors: Bill FROSCH, Central City, IA (US); Brian SNIDER, Walford, IA (US)

(21) Appl. No.: 14/991,666

(22) Filed: Jan. 8, 2016

Related U.S. Application Data
(60) Provisional application No. 62/101,243, filed on Jan. 8, 2015.

(51) Int. Cl. F16K 31/528

(52) U.S. Cl. CPC F16K 31/5286

(57) ABSTRACT

A valve system moving from an open to a closed position for use in the mixing industry that reduces stagnate material above the valve by sealing an opening in a mixing vessel. The valve forms a zero pocket with the opening in the vessel when the valve system is in the closed position. The valve system allows materials to flow to and from the vessel when the valve system is in the open position.

### CROSS-REFERENCE TO RELATED APPLICATIONS

The present application claims priority to provisional patent application 62/101,243 which was filed on Jan. 8, 2015, and is hereby expressly incorporated by reference in its entirety.

### BACKGROUND

During mixing operations and other related industrial operations, materials can accumulate in certain locations, particularly above a valve body. Additionally, valves which extend into a mixing vessel during mixing operations can damage mixing components by coming into contact with parts such as agitators.

It is an object of the invention to minimize a location for material to accumulate in a vessel, accordingly for the invention to form a zero pocket.

It is an object of the invention to provide a valve which open and closes without protruding inside a mixing vessel during mixing operations.

It is also an object of the invention to provide a valve which seals against solids, liquids and gases.

It is a further object of the invention to provide a valve which is easily disassembled for cleaning and sanitation.

### SUMMARY OF THE INVENTION

A valve system having the ability to open and close without protruding inside a mixing vessel or other similar device. The valve known as a zero pocket valve is movable from a closed position to an open position and any position between the closed and opened positions. A telescoping drive shaft transmits torque to a valve. Generally speaking, the invention is meant to seal an opening in the vessel when in the closed position and create a passageway in the open position. The zero pocket valve seals against product inside a mixer creating no pocket of unmixed material common in current valves. The top of the valve has a shape that corresponds to the shape of an inner wall of the opening of the vessel. Accordingly, the top creates a continuous inner wall when the valve is in the closed position; and allows materials to flow to and from the vessel through the passageway when in the open position. Combination linear-rotary motion ensures no part of the valve enters the path of an agitator in the vessel, allowing the agitator to be in motion during discharge. The simple design allows the valve to be easily disassembled and cleaned for sanitary applications

In one embodiment, a cam groove and a cam can be utilized to achieve linear movement of the valve. As the valve rotates, it simultaneously retracts due to the action of the cam groove cam and cam assembly. The cam groove has a first end and a second end that correspond to the open position and the closed position respectively.

### BRIEF DESCRIPTION OF THE DRAWINGS

FIG. 1 is an exploded view of the valve system;

FIG. 2 is a front view of the valve system in which the valve is in a closed position wherein certain details are shown in cross-section;

FIG. 3 is front view of the valve system in which the valve is in a partially open position wherein certain details are shown in cross-section;

FIG. 4 is a front view of the valve system in which the valve is in a fully open position wherein certain details are shown in cross-section;

FIG. 5 is a cross-section of a front view of the valve system in the closed position;

FIG. 6 is a partial cross-section of a front view of the valve system in the open position wherein the valve is not cross-sectioned to show the cam groove.

### DETAILED DESCRIPTION

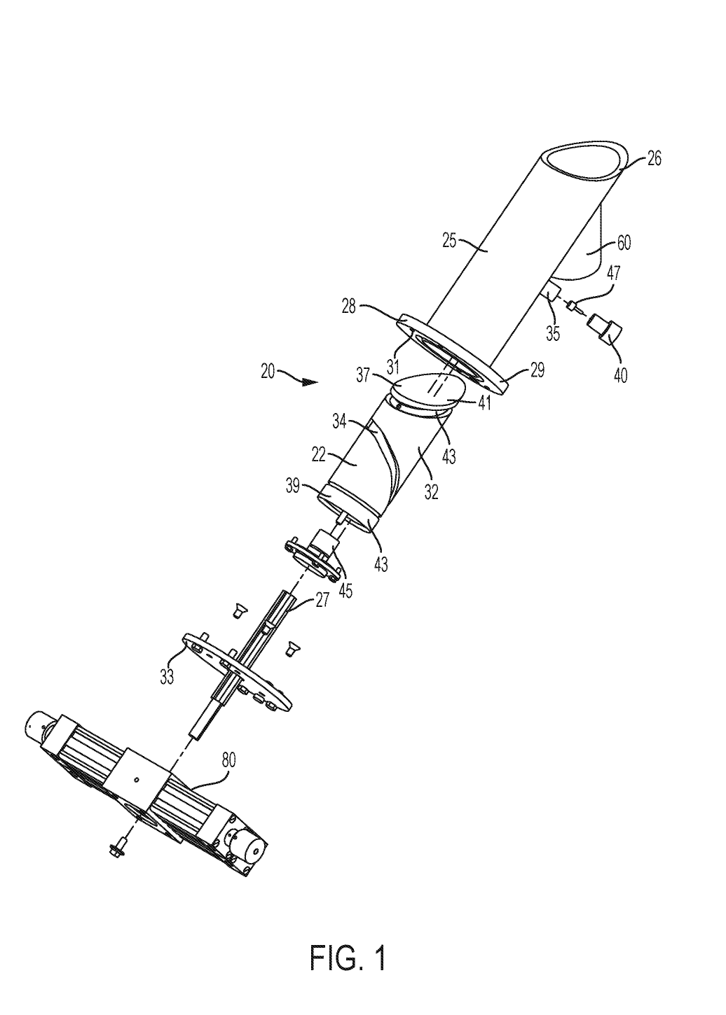

Now referring to the drawings, FIG. 1 shows the parts of a valve system 20. The valve system 20 comprises a valve 22 housed within a valve housing 25. The valve housing 25 has an opening 49. The system 20 further comprises an actuator 80 which is preferably a linear and rotary actuator. The actuator 80 is attached to the valve 22 via a shaft 27.

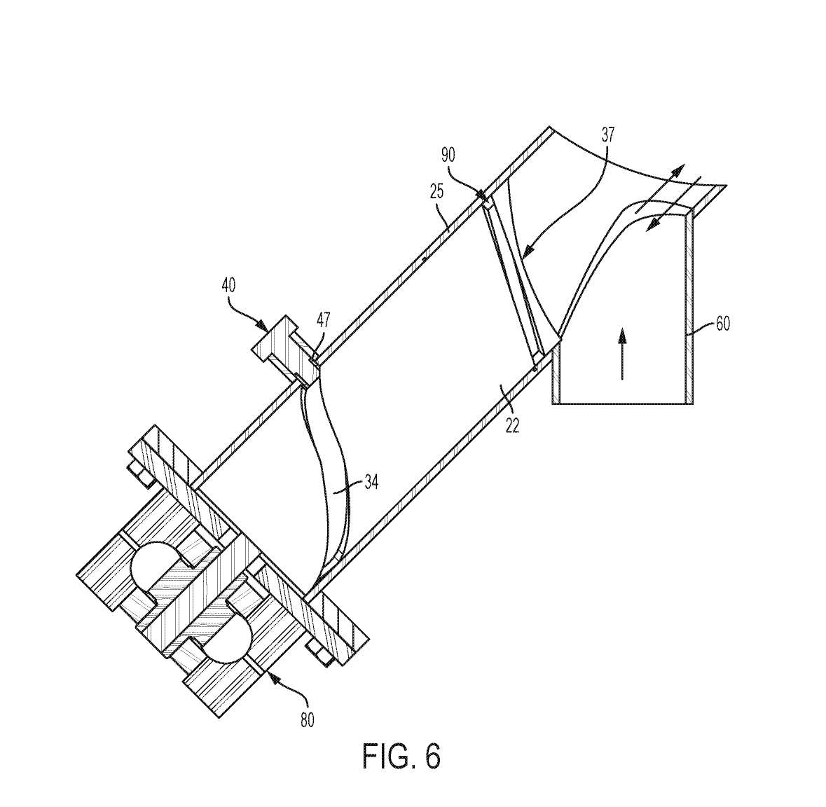

The valve 22 has a top 37 that has a shape corresponding to an opening 51 in an inner wall 53 of a vessel 50. When the valve 22 is in an open position, the top 37 plugs the opening 51 of the vessel 50 such that it makes a continuous inner surface of the inner wall 53. When actuated to an open position, the valve 22 is rotated and moved linearly such that the top 37 does not plug the opening 51 in the vessel 50. Accordingly, material can move to and from the vessel 50 through the opening 51 in the vessel 50 and the opening 49 in the valve housing 25, as a passageway (demonstrated by arrows in FIG. 6) is created for the materials.

While the main aspect of the valve system 20 is to achieve the continuous inner surface of inner wall 53 of the vessel 50 while the valve 22 is in the closed position, and create the passageway while the valve 22 is in the open position; the following description adds additional, specific features that can be used to achieve those results.

Referring again to FIG. 1, the valve housing 25 is cylindrical and has a first end 26 and a second end 28. The first end 26 is shaped such that it corresponds to the shape of a wall of a vessel 50. In the application of a mixing apparatus, the shape of the first end 24 corresponds to the wall of a vessel 50 such as a mixing chamber. The second end 28 comprises a flange 29 which has openings 31 that allow the flange 29 to be attached to an adapter plate 33. The valve housing 25 has a cam tube 35 which is at least partially hollow and threaded for receiving a cam 47 and a cam pin 40. The valve housing 25 has an opening 49 which is in communication with an exterior tube 60. Materials enter the valve housing 25 through opening 49 from the vessel 50, through the valve housing 25 and ultimately enter the exterior tube 60 that can discharge the vessel 50 when the valve system 20 is in an open or partially open position. The flow rate of the materials will be dependent on the extent of the open position.

The valve 22 is cylindrical corresponding to the shape of the valve housing 25. The valve 22 has a top 37 and a bottom 39. The top 37 comprises a contoured plug 41 that corresponds to the shape of the inner wall 53 of the vessel 50. Just below the plug 41, a seal groove 43 provides a profiled seal to block materials from slipping between the valve 22 and the valve housing 25. A cam groove 34 is below an outside surface 32 of the valve 22. The shape and pattern of the cam groove 34 is dependent on the desired motion and movement of the valve 22 and can be shaped and styled accordingly. In the preferred embodiment, the outside surface 32 has at least one cam groove 34 which has a defined path with a first end 36 and a second end 38. Additionally, the preferred embodiment has a valve with the first end 36 and the second end 38 corresponds to a 180 degree rotation of the valve 22. At least one cam pin 40 is in a stationary position and holds a cam 47. At least a portion of one cam 47 is within the cam groove 34. The bottom 39 of the valve 22 comprises a wear strip 43 which allows for a smoother motion while the valve 22 is rotating.

A linkage 45 in the form of a spline nut connects the valve 22 to the shaft 27. Preferably the shaft 27 is a spline shaft. The shaft 27 enters an opening in the adapter plate 33 and then is connected to the rotary actuator 80.

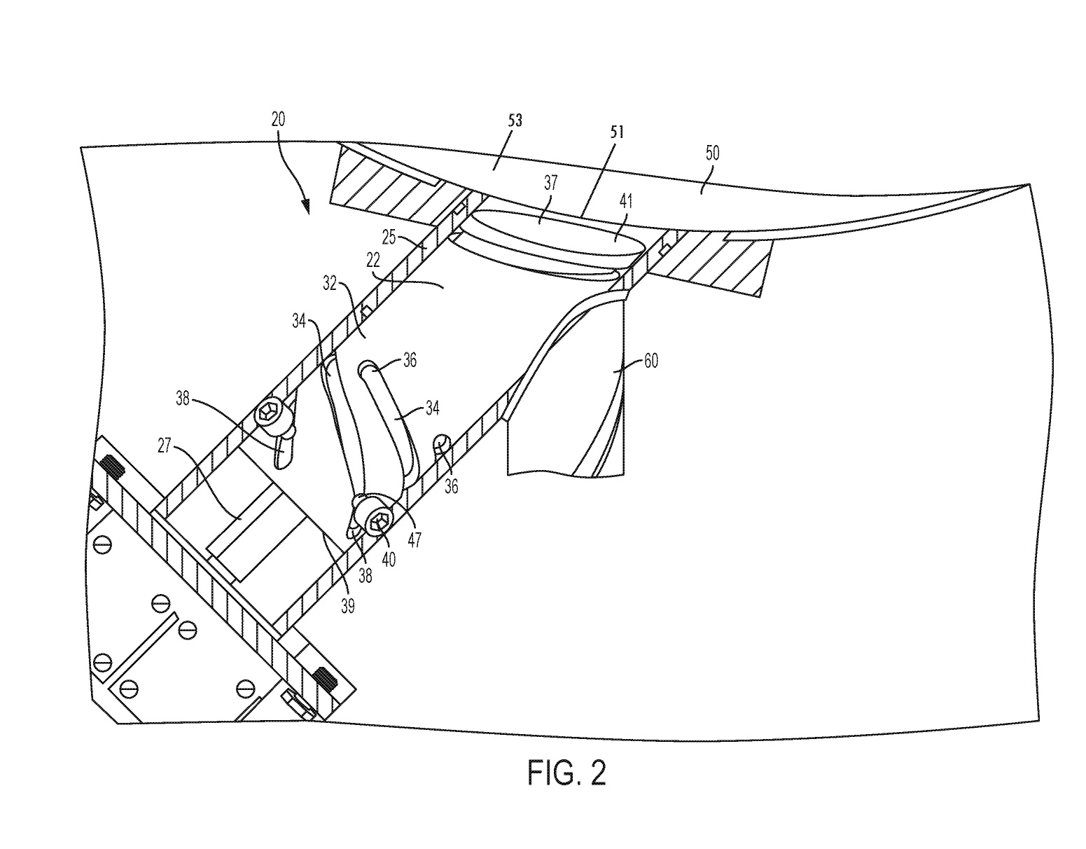

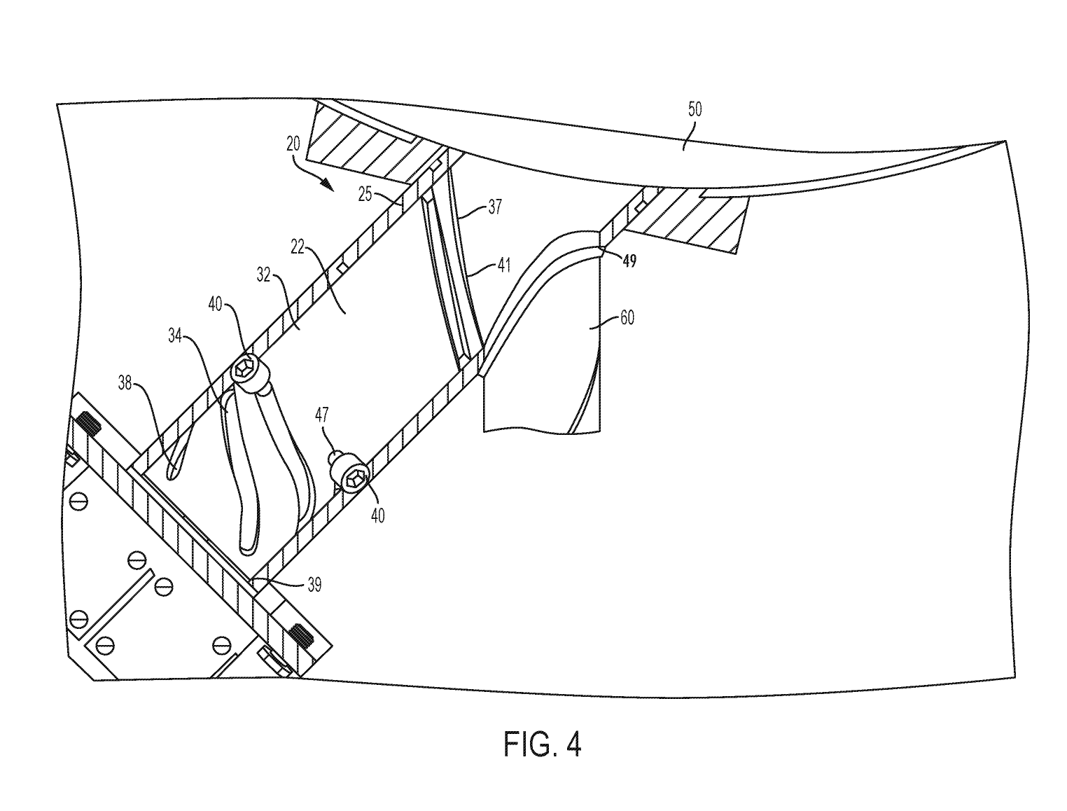

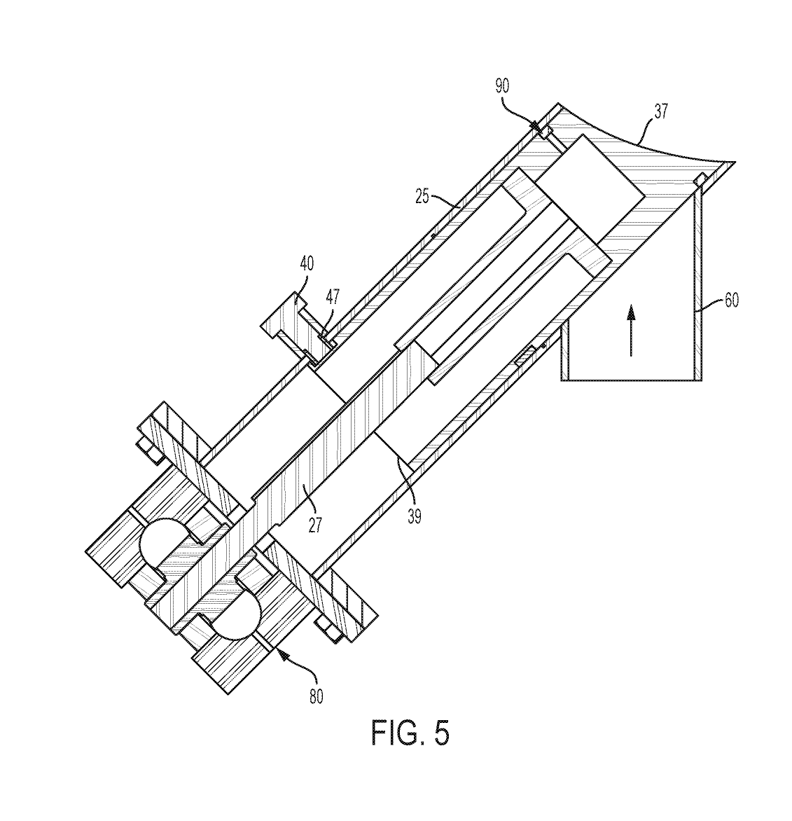

FIGS. 2-4 show a valve system 20 in a closed, partially open, and open setting respectively. In operation, FIG. 2 and FIG. 5 show a substantially closed position in which the exterior tube 60 is prevented from being in communication with the vessel 50. Specifically, the top 37 plugs the opening 51 of the vessel 50. Accordingly, materials cannot flow from an outside source into the vessel 50. Additionally, materials are prevented from flowing out of the vessel 50. The cam 47 is at or near the second end 38 of cam groove 34. Any number of cam grooves 34 and cams 47 are possible. In the closed position, the valve plug 41 is flush with the inner wall 53 of the vessel 50. As seen in FIG. 4, the bottom 39 is in an elevated position which corresponds to the top 37 being in an elevated position as well in the closed position.

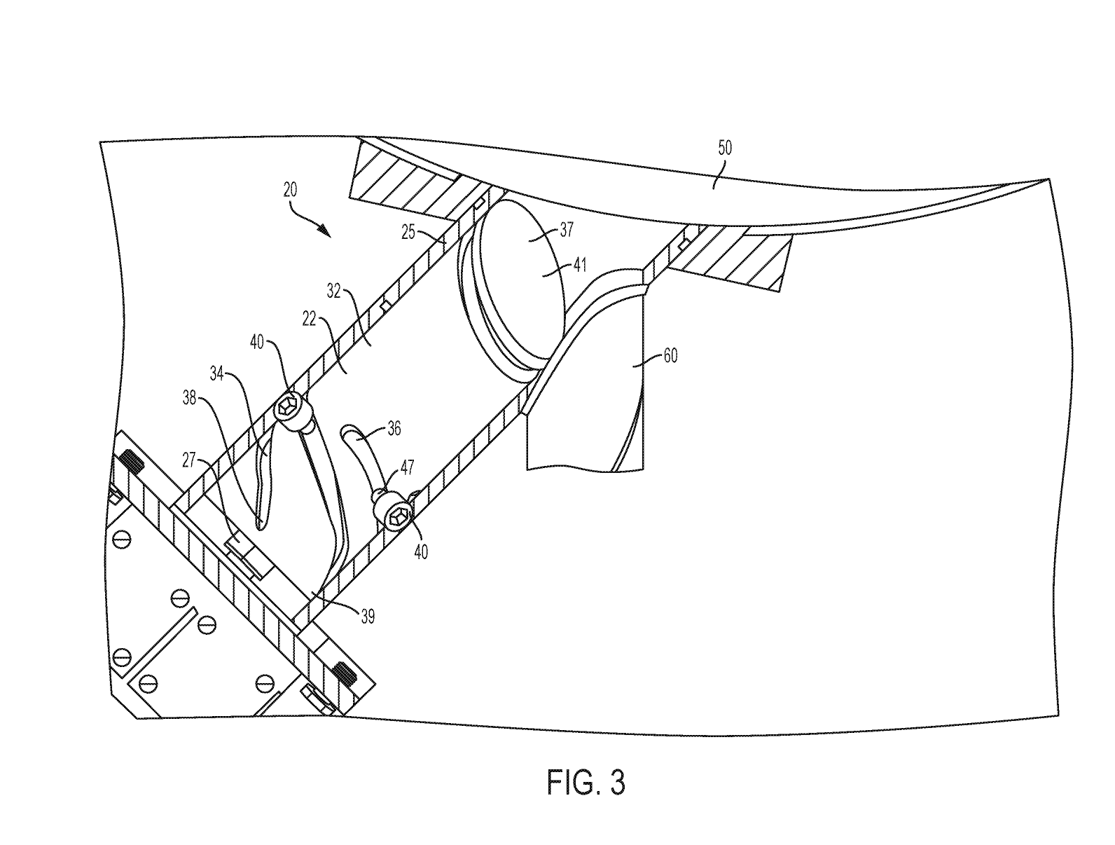

As shown in FIG. 3, a partially open position is achieved by activating the rotary actuator 80. The rotary actuator 80 rotates in a first direction, which depending on the direction and location of the cam groove 34 will be either clockwise or counter clockwise. As the rotary actuator 80 rotates in the first direction, the shaft 27 rotates in the first direction. The shaft 27 rotation then rotates the linkage 45 which in turn rotates the valve 22. As the valve body 25 is mounted to the adapter plate 33, neither the valve housing 25 nor plate 33 rotate. Accordingly, the valve 22 rotates within the valve body 25. As the valve 22 rotates, the cam 47 is forced to follow the cam groove 34 and force the valve 22 downward toward the fully open position and the valve 22 slides over the shaft 27. The rotation can continue until one of the cams 47 reaches the first end 36, although the valve system 20 can be stopped at any position of the cams 47 on the cam groove 34.

As shown in FIG. 4 and FIG. 6, a substantially opened position of the valve system 20 is detailed. The open position allows the vessel 50 to be in complete communication with the exterior tube 60. This allows material to exit the exterior tube 60 and be introduced into vessel 50. Additionally, the system 20 also allows the flow of matter to be reversed if the application is required, wherein matter flows from the vessel 50 to the exterior tube 60 when in an open position. In order for the valve 22 to go from the open position back to the closed position, the rotation of the rotary actuator 80 is reversed to a second direction which is opposite of the first direction. The cam 47 follows the cam groove 34 until the cam 47 reaches the second end 38 again. A seal 90 can be utilized to seal the valve 22 and valve housing 25.

Having thus described the invention in connection with the several embodiments thereof, it will be evident to those skilled in the art that various revisions can be made to the embodiments described herein with out departing from the spirit and scope of the invention. It is the intention, however, that all such revisions and modifications that are evident to those skilled in the art will be included with in the scope of the following claims. Any elements of any embodiments disclosed herein can be used in combination with any elements of other embodiments disclosed herein in any manner to create different embodiments.

What is claimed is:

1. A valve system for a vessel with a vessel opening, comprising:
a valve;
an actuator;
the actuator is a linear and rotary actuator;
wherein the actuator rotates the valve from an open position to a closed position;
the valve has a top;
the top has a shape;
wherein the shape corresponds to a shape of the vessel opening wherein the shape of the top forms a continuous inner surface of the vessel when the valve is in the closed position.

2. The valve system of claim 1, further comprising:
a valve housing;
the valve housing having an opening;
wherein the valve in the open position creates a passageway from the vessel to the opening in the valve housing for materials to flow to and from the vessel and the opening in the valve housing.

3. The valve system of claim 2, further comprising:
a shaft;
a linkage connects the shaft and the valve;
the valve movable over the shaft when the actuator rotates.

4. The valve system of claim 3, further comprising:
a cam groove;
a cam;
the cam movable within the cam groove.

5. The valve system of claim 4, wherein:
the cam groove has a first end and a second end.

6. The valve system of claim 5, wherein:
the first end of the cam groove corresponds to the valve being in the open position when the cam is at the first end.

7. The valve system of claim 6, wherein:
the second end of the cam groove corresponds to the valve being in the closed position when the cam is at the second end.

8. The valve system of claim 7, wherein:
the valve housing has a flange;
wherein the flange is attached to a fixed object to prevent rotation of the valve housing during operation of the valve system.

9. The valve system of claim 8, wherein:
the valve comprises a seal groove.

10. The valve system of claim 9, wherein:
the cam is secured in a pin.

11. The valve system of claim 10, wherein:
the valve has a wear strip.

12. A valve system, comprising:
a valve;
a cam groove;
a cam;
a shaft;
an actuator;
the cam is at least partially contained in the cam groove;
the cam groove has a first end and a second end;
the first end of the cam groove corresponds to the valve body being in the open position when the cam is at the first end;
wherein the actuator rotates the valve from the open position to a closed position.

13. The valve system of claim 12, wherein:
the valve is housed within a valve housing.

14. The valve system of claim 13, wherein:
the shaft transmits torque from the actuator.

15. The valve system of claim 14, wherein:
the valve comprises a seal groove for a profiled seal.

16. The valve system of claim 15, wherein:
a second point of the cam groove corresponds to the closed position.

17. A method for opening and closing a valve to seal an opening in a vessel and create a passageway for flow of material, comprising the steps of:
providing a valve with a top;
placing the valve in a valve housing;
configuring the top to a shape corresponding to the vessel opening wherein the shape of the top forms a continuous inner surface of the vessel when the valve is in a closed position;
providing a linear and rotary actuator;
making an opening in the valve housing;
wherein the valve allows materials to flow to and from the vessel and the valve opening when the valve is in an open position.

18. The method of claim 17, wherein:
at least one cam groove is on a surface of the valve;
the at least one cam groove has a pattern;
providing at least one cam capable of following the pattern;
providing a force to move the valve in a first direction whereby the valve moves from the open position to the closed position;
wherein a point on the cam groove corresponds to the open position.

19. The method of claim 18, further comprising the steps of:
providing a shaft and a linkage;
the linkage connects the shaft and the valve;
the valve movable over the shaft when the actuator rotates.

20. The method of claim 19, wherein:
the valve has a plurality of cam grooves.
